(19) United States
(12) Patent Application Publication
(10) Pub. No.: US 2017/0113535 A1
(43) Pub. Date: Apr. 27, 2017

(54) VEHICLE DRIVING APPARATUS

(71) Applicant: AISIN AW CO., LTD., Anjo-shi, Aichi-ken (JP)

(72) Inventor: Takahisa HIRANO, Anjo (JP)

(73) Assignee: AISIN AW CO., LTD., Anjo-shi, Aichi-ken (JP)

(21) Appl. No.: 15/129,199

(22) PCT Filed: Apr. 14, 2015
(86) PCT No.: PCT/JP2015/061416

§ 371 Date: Sep. 26, 2016

(30) Foreign Application Priority Data
Apr. 22, 2014 (JP) 2014-088228

(51) Int. Cl. B60K 6/445; B60K 6/40; F16H 37/08; B60K 6/365

(52) U.S. Cl. CPC B60K 6/445; B60K 6/365; B60K 6/40; F16H 37/0806; B60K 2006/266

(57) ABSTRACT

A vehicle driving apparatus that includes an input member drive-coupled to an internal combustion engine through a damper, a first rotary electric machine, a second rotary electric machine, a differential gear device, an output device drive-coupled to a wheel, the differential gear device including a first rotary element drive-coupled to the input member, a second rotary element drive-coupled to the first rotary electric machine, and a third rotary element drive-coupled to the output device, and a gear mechanism including a first gear that meshes with an output gear of the second rotary electric machine, a second gear that meshes with an input gear of the output device, and a coupling shaft that couples the first gear and the second gear.

### BACKGROUND

The present disclosure relates to a vehicle driving apparatus including an input member drive-coupled to an internal combustion engine through a damper, a first rotary electric machine, a second rotary electric machine, a differential gear device, and an output device drive-coupled to wheels, and the differential gear device includes a first rotary element drive-coupled to the input member, a second rotary element drive-coupled to the first rotary electric machine, and a third rotary element drive-coupled to the output device.

Known vehicle driving apparatuses as described above are described in Japanese Patent Application Publication No. 2011-183946 (JP 2011-183946 A) (Patent Document 1) and Japanese Patent Application Publication No. 2009-262859 (JP 2009-262859 A) (Patent Document 2). In the following description in this section “BACKGROUND ART,” reference characters used in Japanese Patent Application Publication No. 2011-183946 or Japanese Patent Application Publication No. 2009-262859 are cited in [ ]. Japanese Patent Application Publication No. 2011-183946 describes a configuration including a gear mechanism [C] having a first gear [42] that meshes with an output gear of a second rotary electric machine [MG2], a second gear [43] that meshes with an input gear of an output device [DF], and a coupling shaft [41] coupling a first gear and a second gear, and both the first gear and the second gear are integrally formed with the coupling shaft. Japanese Patent Application Publication No. 2009-262859 describes a configuration including a gear mechanism [T] having a first gear [24] that meshes with an output gear of a second rotary electric machine [MG2], a second gear [26] that meshes with an input gear of an output device [DF], and a coupling shaft [25] coupling the first gear and the second gear. In this configuration, the first gear is coupled to the coupling shaft by spline engagement, and the second gear having a diameter smaller than that of the first gear and a tooth width larger than that of the first gear is integrally formed with the coupling shaft.

### SUMMARY

As illustrated in FIG. 3 of Japanese Patent Application Publication No. 2011-183946 and FIG. 4 of Japanese Patent Application Publication No. 2009-262859, in a case where the gear mechanism is disposed between a damper and the second rotary electric machine in an axial direction, the axial length of a portion of the vehicle driving apparatus where the second rotary electric machine is disposed can be reduced by reducing the axial length of space occupied by the gear mechanism. In the gear mechanism of Japanese Patent Application Publication No. 2011-183946, however, both the first gear and the second gear are integrally formed with the coupling shaft. Thus, as illustrated in FIG. 4 of Japanese Patent Application Publication No. 2011-183946, at least a certain size of a gap in the axial direction is needed in general between the first gear and the second gear due to restrictions in processing on the second gear. This gap tends to increase the axial length of the space occupied by the gear mechanism. In the gear mechanism of Japanese Patent Application Publication No. 2009-262859, the axial length of a spline engagement portion between the first gear and the coupling shaft needs to be relatively large enough to secure an appropriate supporting accuracy of the first gear (see FIG. 4 of Japanese Patent Application Publication No. 2009-262859). The presence of the spline engagement portion for engagement between the first gear and the coupling shaft tends to increase the axial length of the space occupied by the gear mechanism.

To prevent such problems, a vehicle driving apparatus capable of reducing an axial length of space occupied by a gear mechanism is desired.

In view of the above, according to an exemplary characteristic of the disclosure, the vehicle driving apparatus includes an input member drive-coupled to an internal combustion engine through a damper, a first rotary electric machine, a second rotary electric machine, a differential gear device, an output device drive-coupled to a wheel, the differential gear device including a first rotary element drive-coupled to the input member, a second rotary element drive-coupled to the first rotary electric machine, and a third rotary element drive-coupled to the output device, and a gear mechanism including a first gear that meshes with an output gear of the second rotary electric machine, a second gear that meshes with an input gear of the output device, and a coupling shaft that couples the first gear and the second gear, wherein the gear mechanism is disposed between the damper and the second rotary electric machine in an axial direction of the coupling shaft, and is disposed so as to overlap each of the damper and the second rotary electric machine when viewed in the axial direction, the second gear has a diameter smaller than that of the first gear and a tooth width larger than that of the first gear, and is engaged with an engagement portion provided in the coupling shaft on an axial first direction side that is one side of the first gear in the axial direction, and a first bearing that is disposed on an axial second direction side that is an opposite side of the second gear from the axial first direction side and supports the gear mechanism is disposed so as to overlap the first gear when viewed in a radial direction of the coupling shaft.

Note that the term “drive-coupled” herein refers to a state in which two rotary elements are coupled together to be capable of transmitting a driving force (synonym for a torque). This concept includes a state in which two rotary elements are coupled together so as to rotate together and a state in which the two rotary elements are coupled together to be capable of transmitting a driving force through one or more transmission members. Such transmission members include various members (e.g., a shaft, a gear mechanism, and a belt) that transmit rotation at an identical speed or a shifted speed, and may include engagement devices (e.g., a friction engagement device and a meshing engagement device) that selectively transmit rotation and a driving force. The case of using the term “drive-coupled” for a rotary element of the differential gear device refers to a state in which one rotary element is drive-coupled to another through no other rotary elements.

The term “rotary electric machine” refers to any of a motor (electric motor), a generator (electric generator), and a motor generator that functions as both a motor and a generator as necessary.

With regard to arrangement of two members herein, the phrase “overlap when viewed in a certain direction” means that when a virtual line that is parallel to the line of sight moves to a direction perpendicular to the virtual line, the virtual line overlaps both of the two members in at least some regions. Thus, with regard to arrangement of two members, the term “not overlap when viewed in a certain direction” means that when a virtual line that is parallel to the line of sight moves to a direction perpendicular to the virtual line, the virtual line does not overlap any of the two members.

In the characteristic configuration describe above, the second gear is coupled to the coupling shaft by engagement. Accordingly, as compared to a case where both the first gear and the second gear are integrally formed with the coupling shaft, restrictions in manufacturing the gear mechanism can be reduced, so that the first gear and the second gear can be disposed close to each other in the axial direction. As a result, the axial length of space occupied by the gear mechanism can be reduced.

In addition, in the characteristic configuration, since the first bearing is disposed so as to overlap the first gear when viewed in the radial direction of the coupling shaft, an axial length of space occupied by the first gear and the first bearing can be reduced, as compared to a case where the first bearing is disposed so as not to overlap the first gear when viewed in the radial direction. In this regard, the axial length of the space occupied by the gear mechanism can also be reduced.

As described above, according to the characteristic configuration, the axial length of the space occupied by the gear mechanism can be reduced. Accordingly, the damper and the second rotary electric machine that are disposed separately at both sides of the gear mechanism in the axial direction can be disposed close to each other in the axial directions. As a result, the axial length of a portion of the vehicle driving apparatus where the second rotary electric machine is disposed can be reduced.

### BRIEF DESCRIPTION OF THE DRAWINGS

FIG. 1 is a cross-sectional view of a vehicle driving apparatus according to an embodiment.

FIG. 2 is a skeleton diagram of the vehicle driving apparatus according to the embodiment.

FIG. 3 is a view schematically illustrating an arrangement of components of the vehicle driving apparatus according to the embodiment when viewed in an axial direction.

### DETAILED DESCRIPTION OF EMBODIMENTS

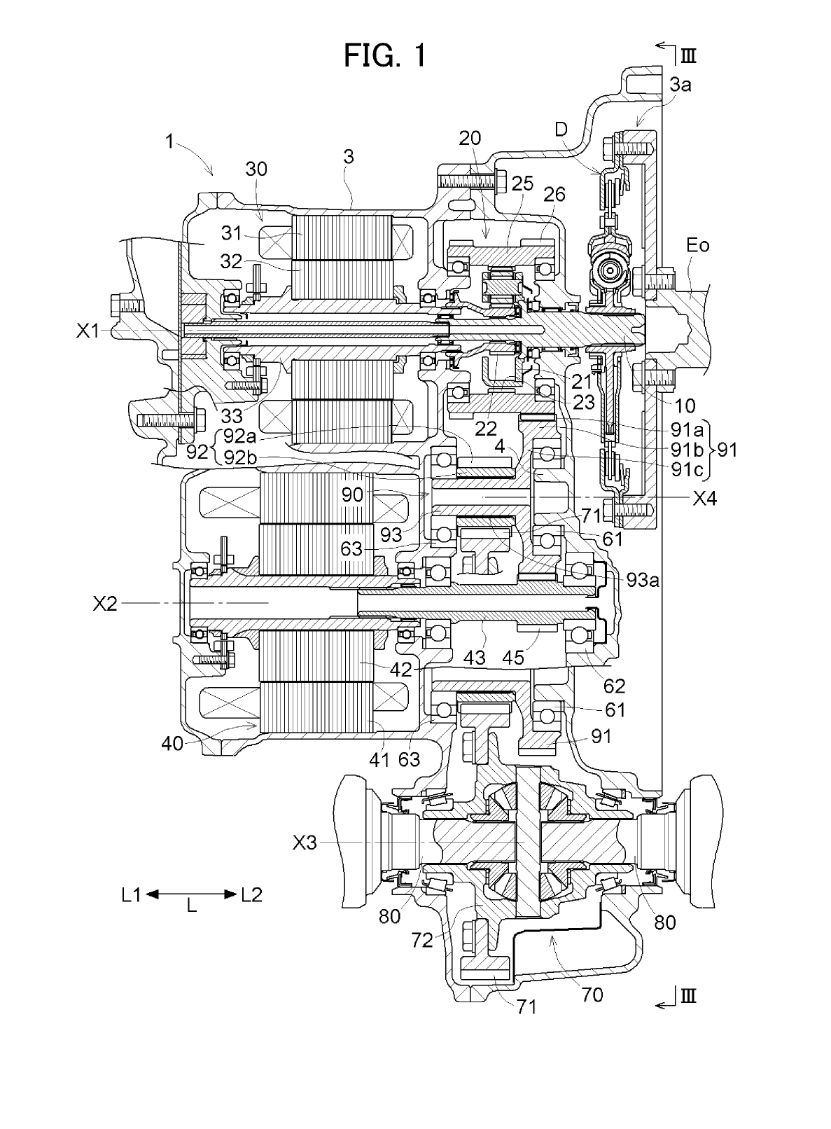

An embodiment of a vehicle driving apparatus will be described with reference to the drawings. In the following description, an “axial direction L,” a “circumferential direction,” and a “radial direction” are defined with reference to a coupling shaft 93 of a gear mechanism 90, i.e., with reference to a fourth axis X4 on which the gear mechanism 90 is disposed (see FIG. 1). An “axial first direction L1” refers to a direction heading toward one side in the axial direction L, and an “axial second direction L2” refers to a direction heading toward the other side in the axial direction L (i.e., the direction opposite to the axial first direction L1). In this embodiment, as illustrated in FIG. 1, the axial first direction L1 is a direction from a damper D toward a second rotary electric machine 40 along the axial direction L. In the following description, terms for components concerning, for example, dimensions, directions, and locations are used as concepts including states having differences due to errors (i.e., errors that may be tolerated in manufacturing). Directions of components are directions in a state in which these components are mounted on a vehicle driving apparatus 1.

### 1. Overall Configuration of Vehicle Driving Apparatus

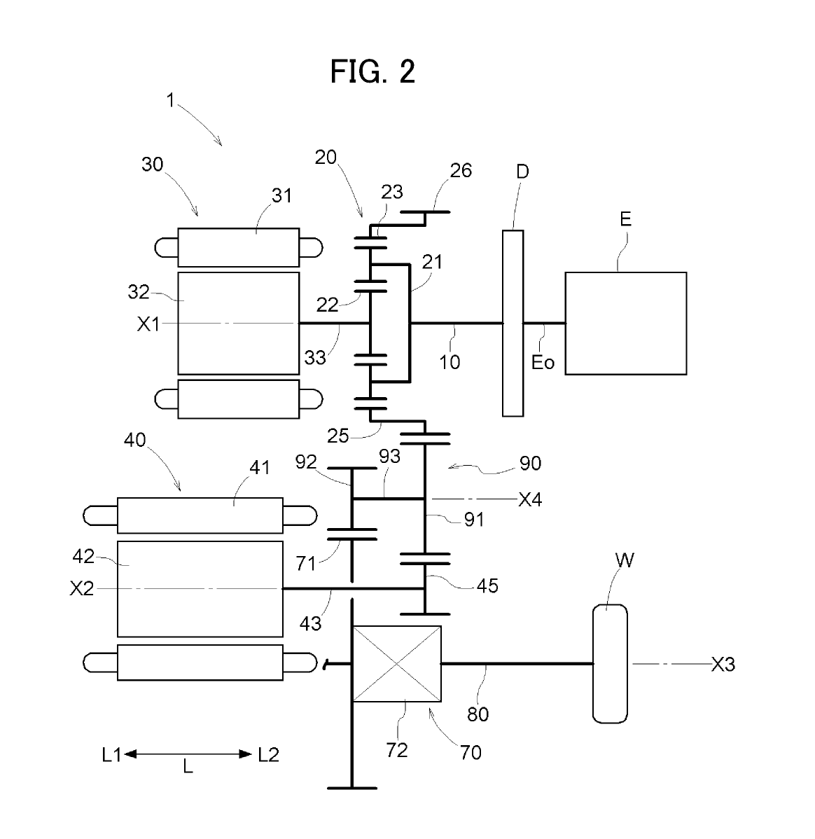

As illustrated in FIGS. 1 and 2, the vehicle driving apparatus 1 includes an input shaft 10 drive-coupled to an internal combustion engine E through the damper D, a first rotary electric machine 30, the second rotary electric machine 40, a differential gear device 20, and an output device 70 drive-coupled to wheels W. The vehicle driving apparatus 1 includes the gear mechanism 90 that transmits a driving force between the second rotary electric machine 40 and the output device 70. As illustrated in FIG. 1, the input shaft 10, the first rotary electric machine 30, the second rotary electric machine 40, the differential gear device 20, the output device 70, and the gear mechanism 90 are housed in a case 3 (driving apparatus case). The case 3 is provided with a damper housing chamber 3a that houses the damper D. The vehicle driving apparatus 1 is a driving apparatus for a hybrid vehicle. The hybrid vehicle herein refers to a vehicle including both an internal combustion engine E and a rotary electric machine (the first rotary electric machine 30 and the second rotary electric machine 40 in this example) as a driving source for wheels W. The vehicle driving apparatus 1 according to this embodiment is structured as a hybrid vehicle driving apparatus of a so-called 2-motor split type. The vehicle driving apparatus 1 according to this embodiment is structured as a driving apparatus for a front engine front drive (FF) vehicle.

As illustrated in FIGS. 1 and 2, the input shaft 10, the differential gear device 20, and the first rotary electric machine 30 are disposed on a first axis X1. The second rotary electric machine 40 is disposed on a second axis X2. The output device 70 is disposed on a third axis X3. The gear mechanism 90 is disposed on the fourth axis X4. The first axis X1, the second axis X2, the third axis X3, and the fourth axis X4 are different axes (virtual axes) from each other. In this embodiment, the first axis X1, the second axis X2, the third axis X3, and the fourth axis X4 are disposed mutually parallel. The input shaft 10, the differential gear device 20, and the first rotary electric machine 30 are arranged in this order on the first axis X1 from the axial second direction L2 side (i.e., from the damper D side in the axial direction L).

The internal combustion engine E is a motor (e.g., a gasoline engine or a diesel engine) that is driven to extract power by combustion of a fuel in the engine. In this embodiment, the input shaft 10 is drive-coupled to an internal combustion engine output shaft Eo that is an output shaft (e.g., a crank shaft) of the internal combustion engine E, through the damper D. The damper D transmits rotation generated by driving the internal combustion engine E to the input shaft 10 and inputs the rotation to the vehicle driving apparatus 1 while absorbing torsional vibrations between the internal combustion engine output shaft Eo and the input shaft 10. The damper D and the internal combustion engine output shaft Eo are coaxially disposed with the input shaft 10 (on the first axis X1). The input shaft 10 is preferably drive-coupled to the internal combustion engine E through, for example, a clutch in addition to the damper D. In this embodiment, the input shaft 10 corresponds to an “input member.”

The first rotary electric machine 30 includes a first stator 31 fixed to the case 3 and a first rotor 32 rotatably supported on the first stator 31. In this example, the first rotor 32 is disposed inside the first stator 31 in a radial direction. The first rotor 32 is coupled to the first rotor shaft 33 so as to rotate together with the first rotor shaft 33. The second rotary electric machine 40 includes a second stator 41 fixed to the case 3 and a second rotor 42 rotatably supported on the second stator 41. In this example, the second rotor 42 is disposed inside the second stator 41 in the radial direction. The second rotor 42 is coupled to a second rotor shaft 43 so as to rotate together with the second rotor shaft 43. Each of the first rotary electric machine 30 and the second rotary electric machine 40 can function as a motor (electric motor) that receives a supply of electric power to generate power and as a generator (electric generator) that receives a supply of power to generate electric power.

The differential gear device 20 includes, as rotary elements, at least a first rotary element 21 drive-coupled to the input shaft 10, a second rotary element 22 drive-coupled to the first rotary electric machine 30, and a third rotary element 23 drive-coupled to the output device 70. As described above, the term “drive-coupled” for a rotary element of the differential gear device refers to a state in which a rotary element is drive-coupled to another rotary element with no other rotary elements of the differential gear device interposed therebetween. Thus, for example, the first rotary element 21 is drive-coupled to the input shaft 10 with none of the other rotary elements of the differential gear device 20, that is, the second rotary element 22 and the third rotary element 23, being interposed therebetween. In this embodiment, the first rotary element 21 is drive-coupled to the input shaft 10 so as to rotate together with the input shaft 10. In this embodiment, the second rotary element 22 is drive-coupled to the first rotary electric machine 30 so as to rotate together with the first rotary electric machine 30. Specifically, the second rotary element 22 (sun gear in this example) is disposed on the axial second direction L2 side (on the damper D side in the axial direction L) of the first rotor shaft 33 that rotates together with the first rotor 32.

In this embodiment, the differential gear device 20 only includes, as rotary elements, the first rotary element 21, the second rotary element 22, and the third rotary element 23, and the third rotary element 23 is also drive-coupled to the second rotary electric machine 40. Specifically, in this embodiment, the differential gear device 20 is constituted by a planetary gear mechanism including three rotary elements of a sun gear, a carrier, and a ring gear. The carrier constitutes the first rotary element 21, the sun gear constitutes the second rotary element 22, and the ring gear constitutes the third rotary element 23. In this embodiment, the planetary gear mechanism constituting the differential gear device 20 is a planetary gear mechanism of a single pinion type. The rotary elements are, in order of rotation speed, the second rotary element 22 (sun gear), the first rotary element 21 (carrier), and the third rotary element 23 (ring gear). The order of rotation speed is the order of rotation speed in rotating states of the rotary elements. The rotation speeds of the rotary elements vary depending on the rotating state of the differential gear device 20. However, the order of rotation speeds of the rotary elements is determined depending on the configuration of the differential gear device 20, and thus, is constant. The descending order of rotation speed of the rotary elements is equal to the order in arrangement on a velocity diagram (alignment chart) of the rotary elements.

The differential gear device 20 functions as a power distribution device. Specifically, the differential gear device 20 according to this embodiment distributes a torque of the input shaft 10 (internal combustion engine E) transmitted to the first rotary element 21 between the second rotary element 22 and the third rotary element 23. To the second rotary element 22, a torque obtained by damping the torque of the internal combustion engine E is distributed. The first rotary electric machine 30 outputs a reaction torque to the torque distributed to the second rotary element 22. At this time, the first rotary electric machine 30 basically functions as a generator, and generates electric power by using the torque distributed to the second rotary element 22. In high-speed travelling of a vehicle or in starting the internal combustion engine E, the first rotary electric machine 30 may function as a motor in some cases. To the third rotary element 23, a torque obtained by damping the torque of the internal combustion engine E is distributed as a torque for driving wheels W.

The differential gear device 20 includes a differential output gear 26 for outputting the torque distributed to the third rotary element 23. In this example, the differential output gear 26 is an external toothed gear. The differential output gear 26 is disposed so as to mesh with a gear of a drive transmission mechanism that transmits a driving force between the differential gear device 20 (third rotary element 23) and the output device 70. In this embodiment, the gear mechanism 90 that transmits a driving force between the second rotary electric machine 40 and the output device 70 is also used in the drive transmission mechanism. That is, in this embodiment, the gear mechanism 90 is structured so as to also transmit a driving force between the differential gear device 20 (third rotary element 23) and the output device 70. Thus, in this embodiment, the differential output gear 26 is disposed so as to mesh with a gear (first gear 91 described later in this example) provided in the gear mechanism 90. In this embodiment, as illustrated in FIG. 1, the third rotary element 23 (ring gear) of the differential gear device 20 is integrally formed with an inner peripheral portion of a cylindrical differential output member 25, and the differential output gear 26 is integrally formed with an outer peripheral portion of the differential output member 25. In this embodiment, the differential output gear 26 is formed at an end portion of the differential output member 25 on the axial second direction L2 side (on the damper D side in the axial direction L).

The second rotary electric machine 40 includes an output gear 45 for outputting a torque of the second rotary electric machine 40. In this example, the output gear 45 is an external toothed gear. In this embodiment, as illustrated in FIG. 1, the output gear 45 is formed in a portion of the second rotor shaft 43 that rotates together with the second rotor 42 on the axial second direction L2 side of the second rotor 42 (on the damper D side in the axial direction L). In this embodiment, the output gear 45 is integrally formed on an outer peripheral portion of the second rotor shaft 43. The vehicle driving apparatus 1 includes a second bearing 62 disposed on the axial second direction L2 side of the output gear 45 (on the damper D side in the axial direction L) and supporting a rotary shaft (second rotor shaft 43 in this example) of the output gear 45. The second bearing 62 is a radial bearing that can receive a load in a radial direction relative to the second bearing 62, and rotatably supports the second rotor shaft 43 on the case 3 in a radial direction relative to the second rotor shaft 43 (radial direction relative to the second axis X2 in this example). In this embodiment, a ball bearing is used as the second bearing 62. In this embodiment, the second bearing 62 supports the second rotor shaft 43 from outside in the radial direction relative to the second rotor shaft 43. The output gear 45 meshes with the first gear 91 of the gear mechanism 90. The second rotary electric machine 40 basically functions as a motor (assist motor), and assists a driving force for causing the vehicle to travel. In decelerating the vehicle, for example, the second rotary electric machine 40 may function as a generator in some cases.

The output device 70 includes an input gear 71 and a body 72 coupled to the input gear 71. In this example, the input gear 71 is an external toothed gear. The input gear 71 meshes with a second gear 92 of the gear mechanism 90. The output device 70 functions as a differential gear device for output. Specifically, the body 72 includes a plurality of bevel gears that mesh with each other and an accommodating case for accommodating these bevel gears, and constitutes a differential gear mechanism. In this embodiment, the body 72 is disposed on the axial second direction L2 side of the input gear 71 (on the damper D side in the axial direction L). The output device 70 distributes and transmits rotation and a torque input from the gear mechanism 90 to the input gear 71 to two left and right output shafts 80 (i.e., two left and right wheels W) in the body 72. A torque from the second rotary electric machine 40 is transmitted to the input gear 71 through the gear mechanism 90. In this embodiment, the gear mechanism 90 is structured so as to transmit a driving force between the differential gear device 20 and the output device 70 as described above. Thus, a torque from the differential gear device 20 is also transmitted to the input gear 71 through the gear mechanism 90. That is, the input gear 71 receives a torque (combined torque) as a combination of the torque from the second rotary electric machine 40 and the torque from the differential gear device 20 obtained by the gear mechanism 90. The configuration of the gear mechanism 90 will be described in detail in the section “2. Configuration of Gear Mechanism.”

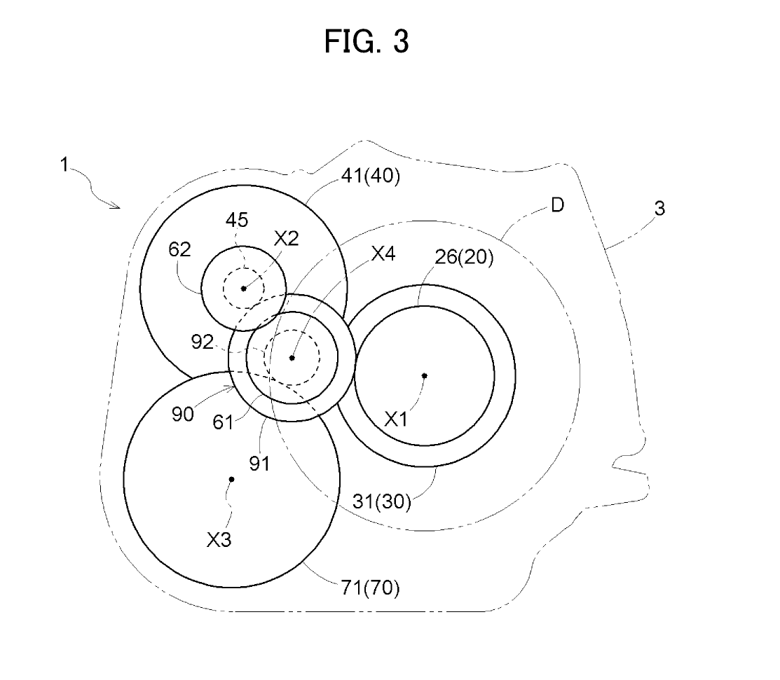

In this embodiment, as illustrated in FIG. 3, the fourth axis X4 is located inside a triangle whose vertexes are the first axis X1, the second axis X2, and the third axis X3, when viewed in the axial direction L. The up-and-down direction and the lateral direction in FIG. 3 coincide with the vertical direction and the horizontal direction (which are front-and-rear direction of the vehicle in this example) in a state in which the vehicle driving apparatus 1 is mounted on the vehicle (on-vehicle state). As illustrated in FIG. 3, in this embodiment, the first axis X1 is disposed on the opposite side of a virtual vertical plane including the fourth axis X4 from the second axis X2 and the third axis X3 in the horizontal direction. The second axis X2 is located above the fourth axis X4 in the vertical direction. The third axis X3 is located below the fourth axis X4 in the vertical direction. The first axis X1 is located between the second axis X2 and the third axis X3 in the vertical direction, and in this example, is located below the fourth axis X4 in the vertical direction.

### 2. Configuration of Gear Mechanism

Next, a configuration of the gear mechanism 90 will be described. As illustrated in FIG. 1, the gear mechanism 90 is disposed between the damper D and the second rotary electric machine 40 in the axial direction L. In this embodiment, the damper D is disposed on the axial second direction L2 side of the gear mechanism 90. The second rotary electric machine 40 is disposed on the axial first direction L1 side of the gear mechanism 90. Thus, in this embodiment, components of the gear mechanism 90 on the axial first direction L1 side are components on the second rotary electric machine 40 side in the axial direction L, and components of the gear mechanism 90 on the axial second direction L2 side are components on the damper D side in the axial direction L. In this embodiment, the first rotary electric machine 30 is also disposed on the axial first direction L1 side of the gear mechanism 90. As illustrated in FIG. 3, the gear mechanism 90 is disposed so as to overlap each of the damper D and the second rotary electric machine 40 when viewed along the axial direction L. In this embodiment, the gear mechanism 90 is disposed so as to also overlap the first rotary electric machine 30 when viewed along the axial direction L. FIG. 3 schematically illustrates an arrangement of components of the vehicle driving apparatus 1 when viewed along the axial direction L. Standard pitch circles are illustrated for gears (i.e., the differential output gear 26, the output gear 45, the input gear 71, the first gear 91, and the second gear 92), and outer peripheral shapes are illustrated for other components (i.e., the damper D, the first stator 31, the second stator 41, the first bearing 61, and the second bearing 62).

As illustrated in FIG. 1, the gear mechanism 90 includes the first gear 91 that meshes with the output gear 45 of the second rotary electric machine 40, the second gear 92 that meshes with the input gear 71 of the output device 70, and the coupling shaft 93 that couples the first gear 91 and the second gear 92 to each other. In this example, the first gear 91 and the second gear 92 are external toothed gears. In this example, the first gear 91 and the second gear 92 are helical gears. The first gear 91 includes a first cylindrical portion 91b formed in a cylindrical shape coaxially with the fourth axis X4, and a first tooth portion 91a that is a tooth portion formed on an outer peripheral portion of the first cylindrical portion 91b. The first gear 91 includes a coupling portion 91c that radially extends to couple the coupling shaft 93 and the first cylindrical portion 91b. The second gear 92 includes a second cylindrical portion 92b formed in a cylindrical shape coaxially with the fourth axis X4, and a second tooth portion 92a that is a tooth portion formed on an outer peripheral portion of the second cylindrical portion 92b. In this embodiment, the first tooth portion 91a corresponds to a “tooth portion” and the first cylindrical portion 91b corresponds to a “cylindrical portion.”

The first gear 91 and the second gear 92 are disposed at different locations in the axial direction L. In this example, the second gear 92 is located on the axial first direction L1 side of the first gear 91. In other words, the first gear 91 is located on the axial second direction L2 side of the second gear 92. The second gear 92 has a diameter smaller than that of the first gear 91 and a tooth width larger than that of the first gear 91. That is, the second cylindrical portion 92b has a diameter smaller than that of the first cylindrical portion 91b. The second tooth portion 92a has a length in the axial direction L larger than that of the first tooth portion 91a, and the length of the second cylindrical portion 92b in the axial direction L is larger than that of the first cylindrical portion 91b accordingly. In this embodiment, as illustrated in FIG. 3, the diameter of the standard pitch circle of the second gear 92 is about 0.4 times as large as that of the standard pitch circle of the first gear 91. In this embodiment, as illustrated in FIG. 1, the tooth width of the second gear 92 is about 1.5 times as large as that of the first gear 91. In this embodiment, the number of teeth of the second gear 92 is smaller than that of the first gear 91.

The vehicle driving apparatus 1 includes the first bearing 61 disposed on the axial second direction L2 side of the second gear 92 and supporting the gear mechanism 90 and the third bearing 63 disposed on the axial first direction L1 side of the second gear 92 and supporting the gear mechanism 90. Each of the first bearing 61 and the third bearing 63 is a radial bearing that can receive a load in a radial direction relative to the bearing, and rotatably supports the gear mechanism 90 on the case 3 in the radial direction. In this embodiment, ball bearings are used as the first bearing 61 and the third bearing 63.

In this embodiment, the gear mechanism 90 functions as a deceleration mechanism (counter deceleration mechanism). Specifically, the gear mechanism 90 decelerates rotation input from the second rotary electric machine 40 to the first gear 91 and amplifies a torque input from the second rotary electric machine 40 to the first gear 91 to transmit the amplified torque to the output device 70 (input gear 71). As described above, in this embodiment, the first gear 91 also meshes with the differential output gear 26 of the differential gear device 20. As illustrated in FIG. 3, the output gear 45 and the differential output gear 26 mesh with the first gear 91 at different locations in the circumferential direction. Thus, in this embodiment, the gear mechanism 90 decelerates rotation input from the differential gear device 20 to the first gear 91 and amplifies a torque input from the differential gear device 20 to the first gear 91 to transmit the amplified torque to the output device 70 (input gear 71).

In consideration of vehicle-mountability of the vehicle driving apparatus 1, the size of the entire apparatus can be preferably reduced as much as possible. A vehicle driving apparatus 1 for an FF vehicle disposed adjacent to the internal combustion engine E in the vehicle width direction is preferably reduced in size especially in the axial direction L. The vehicle driving apparatus 1 according to this embodiment is intended to reduce the axial direction L length of a portion of the vehicle driving apparatus 1 where the second rotary electric machine 40 is disposed (i.e., a portion where the second axis X2 is disposed) by reducing the axial direction L length of space occupied by the gear mechanism 90. This point will be specifically described below.

As illustrated in FIG. 1, the first gear 91 is integrally formed with the coupling shaft 93, and the second gear 92 is engaged with an engagement portion 93a formed in the coupling shaft 93 on the axial first direction L1 side of the first gear 91. That is, the second gear 92 includes an engaged portion that is engaged with the engagement portion 93a. In this embodiment, the engagement portion 93a is an engagement portion (spline engagement portion) for engaging the second gear 92 with the coupling shaft 93 such that the second gear 92 cannot rotate relative to the coupling shaft 93. Specifically, in the engagement portion 93a, external toothed gears (spline teeth) extending in the axial direction L are arranged at regular intervals along the circumferential direction on the outer peripheral portion of the coupling shaft 93. On an inner peripheral portion of the second gear 92 (an inner peripheral portion of the second cylindrical portion 92b in this example), internal teeth (spline teeth) that are engaged portions to mesh with the external toothed gear of the engagement portion 93a are arranged at regular intervals along the circumferential direction. A contour of a tooth surface of the spline teeth may be shaped along an involute curve or along a straight line.

Out of the first gear 91 and the second gear 92 of the gear mechanism 90 disposed in the axial direction L, the first gear 91 having a smaller tooth width than that of the second gear 92 is integrally formed with the coupling shaft 93, and the second gear 92 having a larger tooth width than the first gear 91 is coupled to the coupling shaft 93 by engagement (spline engagement in this embodiment). This structure is employed to reduce the axial direction L length of space occupied by the gear mechanism 90. This is because of the following reasons.

For example, in the case of forming both the first gear 91 and the second gear 92 integrally with the coupling shaft 93, at least a certain size of a gap in the axial direction L is required between the first gear 91 and the second gear 92 due to restrictions in processing in general. In addition, in the case of coupling both the first gear 91 and the second gear 92 to the coupling shaft 93 by engagement, in each of the first gear 91 and the second gear 92, the axial direction L length of a coupling portion (engagement portion) between the gear and the coupling shaft 93 must be set at a length large enough to secure an appropriate supporting accuracy of the gear. Thus, in either case, the axial direction L length of the space occupied by the gear mechanism 90 tends to increase.

On the other hand, in a case where the first gear 91 is integrally formed with the coupling shaft 93 and the second gear 92 is coupled to the coupling shaft 93 by engagement, the first gear 91 and the second gear 92 can be disposed close to each other in the axial direction L, as illustrated in FIG. 1. In the example illustrated in FIG. 1, the second gear 92 (second cylindrical portion 92b) is in contact with the first gear 91 (coupling portion 91c) at the axial first direction L1 side. In addition, since the first gear 91 is integrally formed with the coupling shaft 93, the axial direction L length of the coupling portion between the first gear 91 and the coupling shaft 93 necessary for securing an appropriate supporting accuracy of the first gear 91 (a radially inner side portion of the coupling portion 91c in this example) can be reduced, as compared to a case where the first gear 91 is coupled to the coupling shaft 93 by engagement. As a result, the axial direction L length of the space occupied by the gear mechanism 90 can be reduced.

In this case, since the second gear 92 is coupled to the coupling shaft 93 by engagement, the axial direction L length of the coupling portion (engagement portion 93a) between the second gear 92 and the coupling shaft 93 needs to be set at a length large enough to secure an appropriate supporting accuracy of the second gear 92. In this regard, in consideration of the fact that a tangential force larger than that on the first gear 91 acts on the second gear 92 having a diameter smaller than that of the first gear 91, the tooth width of the second gear 92 is larger than that of the first gear 91. The tangential force acting on the gear is determined in accordance with a value obtained by dividing a torque transmitted to the gear by a radius of the standard pitch circle of the gear. Thus, it is possible to couple the second gear 92 to the coupling shaft 93 by engagement while reducing an increased width of the axial direction L length (including a case where the increased width is zero) of the space occupied by the entire second gear 92 (the second tooth portion 92a and the second cylindrical portion 92b in this example) with reference to a case where the second gear 92 and the coupling shaft 93 are integrally formed. As a result, the first gear 91 is integrally formed with the coupling shaft 93 and the second gear 92 is coupled to the coupling shaft 93 by engagement, so that the axial direction L length of the space occupied by the gear mechanism 90 can be reduced.

To further reduce the axial direction L length of the space occupied by the gear mechanism 90, as illustrated in FIG. 1, the first bearing 61 is disposed so as to overlap the first gear 91 when viewed in the radial direction. In this manner, as compared to a case where the first bearing 61 is disposed on the axial second direction L2 side of the first gear 91 so as not to overlap the first gear 91 when viewed in the radial direction, the axial direction L length of the space occupied by the first gear 91 and the first bearing 61 can be reduced, and consequently, the axial direction L length of the space occupied by the gear mechanism 90 can be reduced.

In this embodiment, the first bearing 61 is disposed so as to support an inner peripheral surface of the first cylindrical portion 91b from the inside in the radial direction. The first cylindrical portion 91b has a portion projecting from the coupling portion 91c in the axial second direction L2, and the inner peripheral surface of this portion is a supported surface supported by the first bearing 61. Specifically, the case 3 includes a cylindrical projecting portion 4 that projects in the axial first direction L1 and is formed in a cylindrical shape coaxially with the fourth axis X4 inside the first cylindrical portion 91b in the radial direction. The cylindrical projecting portion 4 is disposed so as to overlap the first cylindrical portion 91b (the supported surface described above) when viewed in the radial direction, and the first bearing 61 is disposed between the outer peripheral surface of the cylindrical projecting portion 4 and the inner peripheral surface (the supported surface described above) of the first cylindrical portion 91b. In this manner, the first bearing 61 is configured to support the inner peripheral surface of the first cylindrical portion 91b from the inside in the radial direction, so that a part of a load toward the radial inner side acting on the first gear 91 (first tooth portion 91a) can be received by the first bearing 61. A load toward the inside in the radial direction acting on the coupling portion 91c can be reduced accordingly. As a result, the axial direction L length (thickness) of the coupling portion 91c can be reduced, so that the axial direction L length of the space occupied by the gear mechanism 90 can be reduced.

As described above, the configurations described above in the vehicle driving apparatus 1 according to this embodiment enables reduction of the axial direction L length of the space occupied by the gear mechanism 90. In this manner, the damper D and the second rotary electric machine 40 that are disposed separately at both sides of the gear mechanism 90 in the axial direction L can be disposed close to each other in the axial direction L. As a result, the axial direction L length of a portion of the vehicle driving apparatus 1 where the second rotary electric machine 40 is disposed can be reduced. In this embodiment, a configuration as described below is also used to reduce the axial direction L length of a portion of the vehicle driving apparatus 1 where the second rotary electric machine 40 is disposed.

As illustrated in FIG. 3, in this embodiment, the second bearing 62 is disposed so as not to overlap the damper D when viewed in the axial direction L. Thus, as illustrated in FIG. 1, the second rotor shaft 43 can be disposed toward the axial second direction L2 side (on the damper D side in the axial direction L). In this embodiment, the second rotor shaft 43 is disposed toward the axial second direction L2 side to such a degree that the second bearing 62 overlaps the damper housing chamber 3a when viewed in the radial direction. That is, in this embodiment, the second bearing 62 is disposed so as to overlap the damper housing chamber 3a when viewed in the radial direction. Since the second rotor shaft 43 is disposed toward the axial second direction L2 side, the second rotary electric machine 40 can also be disposed toward the axial second direction L2 side accordingly. At this time, although the second bearing 62 projects in the axial second direction L2, the second bearing 62 is disposed closer to the axial first direction L1 side than an end face of the damper D on the axial second direction L2 side, and thus, the second bearing 62 does not project in the axial second direction L2 as a whole. As a result, the axial direction L length of a portion of the vehicle driving apparatus 1 where the second rotary electric machine 40 is disposed can be further reduced.

In this embodiment, as illustrated in FIG. 3, the second bearing 62 is disposed so as to overlap the first gear 91 when viewed in the axial direction L. Specifically, the second bearing 62 is disposed so as to overlap the entire area of the first tooth portion 91a in the radial direction, the entire area of the first cylindrical portion 91b in the radial direction, and an outer part of the coupling portion 91c in the radial direction, when viewed in the axial direction L. Thus, space where the first bearing 61 is disposed so as to overlap the first gear 91 when viewed in the radial direction is susceptible to restrictions by the second bearing 62. In this regard, in this embodiment, as illustrated in FIG. 1, the second bearing 62 is disposed so as not to overlap the first gear 91 when viewed in the radial direction on the axial second direction L2 side of the first gear 91. In this example, the second bearing 62 is also disposed so as not to overlap the first bearing 61 when viewed in the radial direction. In this manner, the first bearing 61 having a large diameter can be used while avoiding interference with the second bearing 62. In this embodiment, a bearing having a diameter large enough to overlap the second bearing 62 when viewed in the axial direction L is used as the first bearing 61. In this manner, the first bearing 61 having a large diameter can be used. As a result, even in the case of using a ball bearing generally having a drag loss smaller than that of a tapered roller bearing as the first bearing 61 as in this example of the embodiment, an appropriate load capacity for a load in the radial direction can be secured.

### 3. Other Embodiments

Other embodiments of the vehicle driving apparatus will be described. Configurations described in the following embodiments may be combined with those of other embodiments as far as no contradiction arises.

(1) In the configuration of the embodiment described above, the first bearing 61 supports the inner peripheral surface of the first cylindrical portion 91b of the first gear 91 from the inside in the radial direction. However, embodiments of the vehicle driving apparatus are not limited to this. For example, in a configuration in which the coupling shaft 93 has an extension portion extending in the axial second direction L2 relative to the coupling portion with the coupling portion 91c, the first bearing 61 may rotatably support an outer peripheral portion of the extension portion on the case 3 from the outside in the radial direction, inside the first cylindrical portion 91b in the radial direction.

(2) In the configuration of the embodiment described above, the second bearing 62 is disposed so as to overlap the first gear 91 without overlapping the damper D when viewed in the axial direction L, and to overlap the damper housing chamber 3a without overlapping the first gear 91 when viewed in the radial direction. However, embodiments of the vehicle driving apparatus are not limited to this. For example, the second bearing 62 may be disposed so as to overlap the damper D when viewed in the axial direction L and not to overlap the damper housing chamber 3a when viewed in the radial direction R, or alternatively, the second bearing 62 may be disposed so as to overlap the first bearing 61 or the first gear 91 when viewed in the radial direction R.

(3) In the configuration of the embodiment described above, the gear mechanism 90 is also used for the drive transmission mechanism that transmits a driving force between the differential gear device 20 (third rotary element 23) and the output device 70. However, embodiments of the vehicle driving apparatus are not limited to this. For example, a drive transmission mechanism (e.g., a counter gear mechanism) that transmits a driving force between the differential gear device 20 and the output device 70 may be provided in addition to the gear mechanism 90, or the differential output gear 26 of the differential gear device 20 may directly mesh with the input gear 71 of the output device 70.

(4) In the configuration of the embodiment described above, the differential gear device 20 only includes, as rotary elements, the first rotary element 21, the second rotary element 22, and the third rotary element 23. However, embodiments of the vehicle driving apparatus are not limited to this. For example, the differential gear device 20 may include, as a rotary element, a fourth rotary element in addition to the first rotary element 21, the second rotary element 22, and the third rotary element 23, so that the fourth rotary element is drive-coupled to the second rotary electric machine 40. In the case of the embodiment described above, the order of rotation speed of the rotary elements of the differential gear device 20 are the second rotary element 22, the first rotary element 21, and the third rotary element 23. However, the embodiments of the vehicle driving apparatus are not limited to this. For example, the differential gear device 20 may be constituted by a planetary gear mechanism of a double-pinion type, so that the order of rotation speed of the rotary elements of the differential gear device 20 is the second rotary element 22, the third rotary element 23, and the first rotary element 21. In this case, the differential gear device 20 combines a torque of the input shaft 10 (internal combustion engine E) transmitted to the first rotary element 21 and a torque of the first rotary electric machine 30 transmitted to the second rotary element 22 and transmits the combined torque to the third rotary element 23.

(5) In regard to other configurations, embodiments disclosed herein are merely examples in all respects, and it should be understood that the present disclosure is not limited to these embodiments. Those skilled in the art would easily understand that modifications can be made as appropriate without departing from the scope of the present disclosure. Thus, other embodiments modified without departing from the scope of the present disclosure are naturally included in the present disclosure.

### 4. Summary of Embodiments

A summary of the vehicle driving apparatus described above will now be described.

A vehicle driving apparatus (1) includes an input member (10) drive-coupled to an internal combustion engine (E) through a damper (D), a first rotary electric machine (30), a second rotary electric machine (40), a differential gear device (20), and an output device (70) drive-coupled to a wheel (W), the differential gear device (20) includes a first rotary element (21) drive-coupled to the input member (10), a second rotary element (22) drive-coupled to the first rotary electric machine (30), and a third rotary element (23) drive-coupled to the output device (70), and the vehicle driving apparatus (1) further includes: a gear mechanism (90) including a first gear (91) that meshes with an output gear (45) of the second rotary electric machine (40), a second gear (92) that meshes with an input gear (71) of the output device (70), and a coupling shaft (93) that couples the first gear (91) and the second gear (92), wherein the gear mechanism (90) is disposed between the damper (D) and the second rotary electric machine (40) in an axial direction (L) of the coupling shaft (93), and is disposed so as to overlap each of the damper (D) and the second rotary electric machine (40) when viewed in the axial direction (L), the second gear (92) has a diameter smaller than that of the first gear (91) and a tooth width larger than that of the first gear (91), and is engaged with an engagement portion (93a) provided in the coupling shaft (93) on an axial first direction (L1) side that is one side of the first gear (91) in the axial direction (L), and a first bearing (61) that is disposed on an axial second direction (L2) side that is an opposite side of the second gear (92) from the axial first direction (L1) side and supports the gear mechanism (90) is disposed so as to overlap the first gear (91) when viewed in a radial direction of the coupling shaft (93).

In the configuration described above, the second gear (92) is coupled to the coupling shaft (93) by engagement. Accordingly, as compared to a case where both the first gear (91) and the second gear (92) are integrally formed with the coupling shaft (93), restrictions in manufacturing the gear mechanism (90) can be reduced, so that the first gear (91) and the second gear (92) can be disposed close to each other in the axial direction (L). As a result, the axial direction (L) length of space occupied by the gear mechanism (90) can be reduced.

In addition, in the configuration described above, since the first bearing (61) is disposed so as to overlap the first gear (91) when viewed in the radial direction (R) of the coupling shaft (93), the axial direction (L) length of space occupied by the first gear (91) and the first bearing (61) can be reduced, as compared to a case where the first bearing (61) is disposed so as not overlap the first gear (93) when viewed in the radial direction. In this regard, the axial direction (L) length of space occupied by the gear mechanism (90) can also be reduced.

As described above, in the configuration described above, the axial direction (L) length of the space occupied by the gear mechanism (90) can be reduced. As a result, the damper (D) and the second rotary electric machine (40) that are disposed separately at both sides of the gear mechanism (90) in the axial direction (L) can be disposed close to each other in the axial directions (L). As a result, the axial direction (L) length of a portion of the vehicle driving apparatus (1) where the second rotary electric machine (40) is disposed can be reduced.

In this embodiment, the first gear (91) is preferably integrally formed with the coupling shaft (93).

In this configuration, out of the first gear (91) and the second gear (92), the second gear (92) having a tooth width larger than that of the first gear (91) is coupled to the coupling shaft (93) by engagement, and thus, as compared to a case where the first gear (91) having a tooth width smaller than that of the second gear (92) is coupled to the coupling shaft (93) by engagement, the axial direction (L) length of the space occupied by the gear mechanism (90) can be reduced. In addition, the axial direction (L) length of the coupling portion between the gear coupled to the coupling shaft (93) by engagement and the coupling shaft (93) needs to be set at a length large enough to secure an appropriate supporting accuracy of the gear. In this regard, in the configuration described above, out of the first gear (91) and the second gear (92), the second gear (92) having a tooth width larger than that of the first gear (91) is coupled to the coupling shaft (93) by engagement, and thus, as compared to a case where the first gear (91) having a tooth width smaller than that of the second gear (92) is coupled to the coupling shaft (93) by engagement, an increased width of the axial direction (L) length of space occupied by the entire gear with reference to a case where the first gear (91) is integrally formed with the coupling shaft (93) can be reduced. As a result, the axial direction (L) length of the space occupied by the gear mechanism (90) can also be reduced.

It is preferable that the first gear (91) includes a cylindrical portion (91b) and a tooth portion (91a) provided on an outer peripheral portion of the cylindrical portion (91b), and the first bearing (61) supports an inner peripheral surface of the cylindrical portion (91b) from inside in the radial direction.

With this configuration, a part of a load toward the radial inner side acting on the tooth portion (91a) of the first gear (91) can be received by the first bearing (61), and a load toward the radial inner side acting on the coupling portion (91c) that couples the cylindrical portion (91b) and the coupling shaft (93) together can be reduced accordingly. As a result, the axial direction (L) length (thickness) of the coupling portion (91c) can be reduced, so that the axial direction (L) length of the space occupied by the gear mechanism (90) can be reduced.

It is preferable that the vehicle driving apparatus further includes a second bearing (62) that is disposed on the axial second direction (L2) side of the output gear (45) and supports a rotary shaft of the output gear (45), the damper (D) is disposed on the axial second direction (L2) side of the gear mechanism (90), and the second bearing (62) is disposed so as to overlap the first gear (91) without overlapping the damper (D) when viewed in the axial direction (L), and to overlap a damper housing chamber (3a) that houses the damper (D) without overlapping the first gear (91) when viewed in the radial direction.

With this configuration, the second bearing (62) is disposed so as not to overlap the damper (D) when viewed in the axial direction (L). Thus, the rotary shaft of the output gear (45) of the second rotary electric machine (40) supported by the second bearing (62) can be disposed toward the axial second direction (L2) side, that is, the damper (D) side in the axial direction (L). Accordingly, the second rotary electric machine (40) can be disposed toward the axial second direction (L2) side. In addition, since the second bearing (62) is disposed so as to overlap the damper housing chamber (3a) when viewed in the radial direction, the amount of projection of the second bearing (62) in the axial second direction (L2) toward the damper (D) can be reduced to zero or a small amount. In this manner, with the configuration described above, while the amount of projection of the second bearing (62) in the axial second direction (L2) toward the damper (D) is reduced to zero or a small amount, the second rotary electric machine (40) can be disposed toward the axial second direction (L2) side. Thus, the axial direction (L) length of a portion of the vehicle driving apparatus (1) where the second rotary electric machine (40) is disposed can be reduced.

With the configuration described above, the second bearing (62) is disposed so as not to overlap the first gear (91) when viewed in the radial direction. Thus, a bearing having a large diameter can be used as the first bearing (61) disposed so as to overlap the first gear (91) when viewed in the radial direction while avoiding interference with the second bearing (62). As a result, a load capacity for a load in the radial direction can be easily secured for the first bearing (61), and restrains on the configuration of the bearing that can be employed as the first bearing (61) can be reduced.

### INDUSTRIAL APPLICABILITY

A technique according to the present disclosure can be used for a vehicle driving apparatus including an input member drive-coupled to an internal combustion engine through a damper, a first rotary electric machine, a second rotary electric machine, a differential gear device, and an output device drive-coupled to wheels, and the differential gear device includes a first rotary element drive-coupled to the input member, a second rotary element drive-coupled to the first rotary electric machine, and a third rotary element drive-coupled to the output device.

1. A vehicle driving apparatus comprising:
an input member drive-coupled to an internal combustion engine through a damper,
a first rotary electric machine,
a second rotary electric machine,
a differential gear device,
an output device drive-coupled to a wheel, the differential gear device including a first rotary element drive-coupled to the input member, a second rotary element drive-coupled to the first rotary electric machine, and a third rotary element drive-coupled to the output device, and
a gear mechanism including a first gear that meshes with an output gear of the second rotary electric machine, a second gear that meshes with an input gear of the output device, and a coupling shaft that couples the first gear and the second gear, wherein
the gear mechanism is disposed between the damper and the second rotary electric machine in an axial direction of the coupling shaft, and is disposed so as to overlap each of the damper and the second rotary electric machine when viewed in the axial direction,
the second gear has a diameter smaller than that of the first gear and a tooth width larger than that of the first gear, and is engaged with an engagement portion provided in the coupling shaft on an axial first direction side that is one side of the first gear in the axial direction, and
a first bearing that is disposed on an axial second direction side that is an opposite side of the second gear from the axial first direction side and supports the gear mechanism is disposed so as to overlap the first gear when viewed in a radial direction of the coupling shaft.

2. The vehicle driving apparatus according to claim 1, wherein the first gear is integrally formed with the coupling shaft.

3. The vehicle driving apparatus according to claim 2, wherein the first gear includes a cylindrical portion and a tooth portion formed on an outer peripheral portion of the cylindrical portion, and
the first bearing supports an inner peripheral surface of the cylindrical portion from inside in the radial direction.

4. The vehicle driving apparatus according to claim 3, further comprising a second bearing that is disposed on the axial second direction side of the output gear and supports a rotary shaft of the output gear, wherein
the damper is disposed on the axial second direction side of the gear mechanism, and
the second bearing is disposed so as to overlap the first gear without overlapping the damper when viewed in the axial direction, and to overlap a damper housing chamber that houses the damper without overlapping the first gear when viewed in the radial direction.

5. The vehicle driving apparatus according to claim 1, wherein the first gear includes a cylindrical portion and a tooth portion formed on an outer peripheral portion of the cylindrical portion, and
the first bearing supports an inner peripheral surface of the cylindrical portion from inside in the radial direction.

6. The vehicle driving apparatus according to claim 1, further comprising a second bearing that is disposed on the axial second direction side of the output gear and supports a rotary shaft of the output gear, wherein
the damper is disposed on the axial second direction side of the gear mechanism, and
the second bearing is disposed so as to overlap the first gear without overlapping the damper when viewed in the axial direction, and to overlap a damper housing chamber that houses the damper without overlapping the first gear when viewed in the radial direction.

7. The vehicle driving apparatus according to claim 2, further comprising a second bearing that is disposed on the axial second direction side of the output gear and supports a rotary shaft of the output gear, wherein
the damper is disposed on the axial second direction side of the gear mechanism, and
the second bearing is disposed so as to overlap the first gear without overlapping the damper when viewed in the axial direction, and to overlap a damper housing chamber that houses the damper without overlapping the first gear when viewed in the radial direction.

8. The vehicle driving apparatus according to claim 5, further comprising a second bearing that is disposed on the axial second direction side of the output gear and supports a rotary shaft of the output gear, wherein
the damper is disposed on the axial second direction side of the gear mechanism, and
the second bearing is disposed so as to overlap the first gear without overlapping the damper when viewed in the axial direction, and to overlap a damper housing chamber that houses the damper without overlapping the first gear when viewed in the radial direction.
